(19) United States
(12) Patent Application Publication
(10) Pub. No.: US 2015/0066781 A1
(43) Pub. Date: Mar. 5, 2015

(54) Prognostics-Based Estimator

(71) Applicant: Snap-on Incorporated, Kenosha, WI (US)

(72) Inventors: Lester B. Johnson, Escondido, CA (US); David R. Costantino, San Diego, CA (US); Bradley R. Lewis, Gilroy, CA (US); Roy S. Brozovich, Campbell, CA (US)

(73) Assignee: Snap-on Incorporated, Kenosha, WI (US)

(21) Appl. No.: 14/019,503

(22) Filed: Sep. 5, 2013

(51) Int. Cl. G06Q 30/02; G06Q 10/00

(52) U.S. Cl. CPC G06Q 30/0206; G06Q 10/20
USPC 705/305

(57) ABSTRACT

Described herein are methods and devices for determining estimate information related to at least one potential vehicle fix for a vehicle based on vehicle information and content of a vehicle repair database. According to an example method, a computing device can receive vehicle information that includes a vehicle identifier and vehicle-usage data for a vehicle. The computing device can then determine repair information that relates to the vehicle from the vehicle repair database based on the vehicle information. The repair information can include at least one potential vehicle fix to a given malfunction. The example method can further involve determining estimate information related to the at least one potential vehicle fix and providing the estimate information to a communication network.

### BACKGROUND

All vehicles produced by manufacturers occasionally have to be repaired. In some cases, a vehicle owner may notice a change in the performance of their vehicle, prompting the vehicle owner to bring the vehicle to a repair shop to diagnose a problem and potentially repair the vehicle. In other cases, an electronic control module of the vehicle may detect a fault and provide a malfunction indication via an instrument panel of the vehicle. If the vehicle owner notices the indication, the vehicle owner may bring their vehicle to a repair shop for service. In either scenario, the vehicle owner may be unaware of what type of service needs to be performed on the vehicle as well as the costs and labor time associated with the repair.

When an operator brings their vehicle to a repair shop for service, it is generally expected and many times a legal requirement that a repair shop provide an estimate of charges to a customer prior to proceeding with the repair of the vehicle. In many cases, (as the examples above cite), diagnostic efforts must be accomplished to derive a root cause and therefore an estimate of the repairs needed to address the symptom of the vehicle. Today the repair shop may offer to diagnose the vehicle and contact the vehicle owner later once the root cause has been identified. After the root cause has been identified, a service writer may prepare a revised estimate of the repair costs and time. In many cases, by the time a specific repair estimate has been prepared, the vehicle owner is off-site. For instance, the vehicle owner may be at work or at home and may not be easily accessible. Additionally, in some instances, the repair shop may also charge the vehicle owner a diagnostic charge to cover the time needed by the repair shop to identify the root cause of a vehicle malfunction and prepare the estimate. Improvements are therefore desired.

### SUMMARY

When a vehicle is brought into a repair shop without a known repair to be performed, currently, there is not an efficient method for the service writer to give guidance on possible repairs and associated charges. Described herein are methods and devices for determining estimate information related to at least one potential vehicle fix for a vehicle based on vehicle information and content of a vehicle repair database. In some instances, the vehicle repair database can include data gathered from multiple repair shops regarding repairs performed on various vehicles by the multiple repair shops. As described herein, the data of the vehicle repair database can be used to determine frequencies with which problems with a vehicle arise, as well as associated charges that could result, based on historical failure data for particular vehicles or vehicle types.

In one example aspect, a method is provided that involves receiving vehicle information at a computing device. The vehicle information can include a vehicle identifier and vehicle-usage data for a vehicle. The method also involves determining, by the computing device and based on the vehicle information, repair information that relates to the vehicle from a vehicle repair database. The repair information can include at least one potential vehicle fix to a given malfunction. The method further involves determining, by the computing device, estimate information related to the at least one potential vehicle fix. The estimate information related to the at least one potential vehicle fix can include at least one of a repair time and a repair cost. Additionally, the method involves providing, from the computing device to a communication network, the estimate information related to the at least one potential vehicle fix.

In another example aspect, a computing device that includes at least one processor and a computer-readable medium is provided. The computer-readable medium is configured to store instructions, that when executed by the at least one processor, cause the computing device to perform functions. The functions include receiving vehicle information comprising a vehicle identifier and vehicle-usage data for a vehicle. The functions also include based on the vehicle information, determining repair information that relates to the vehicle from a vehicle repair database. The repair information can include at least one potential vehicle fix to a given malfunction. The functions further include determining estimate information related to the at least one potential vehicle fix. The estimate information related to the at least one potential vehicle fix can include at least one of a repair time and a repair cost. Additionally, the functions include providing, to a communication network, the estimate information related to the at least one potential vehicle fix.

In another aspect, a method is provided that involves receiving, via an interface of a computing device, vehicle information. The vehicle information can include a vehicle identifier and vehicle-usage data for a vehicle. The method further involves providing, by the computing device, the vehicle information to a communication network. Additionally, the method involves receiving from the communication network, at the computing device, estimate information related to at least one potential vehicle fix for the vehicle. The estimate information related to the at least one potential vehicle fix can include at least one of a repair time and a repair cost.

In still another aspect, a computing device that includes at least one processor and a computer-readable medium is provided. The computer-readable medium is configured to store instructions, that when executed by the at least one processor, cause the computing device to perform functions. The functions include receiving, via an interface of the computing device, vehicle information. The vehicle information can include a vehicle identifier and vehicle-usage data for a vehicle. The functions also include providing the vehicle information to a communication network. The functions further include receiving, at the interface and from the communication network, estimate information related to at least one potential vehicle fix to a given malfunction. The estimate information related to the at least on potential vehicle fix can include at least one of a repair time and a repair cost.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates an example system.

FIG. 2 is a block diagram of an example method for determining estimate information.

FIGS. 3A, 3B, 4A, 4B, and 4C are conceptual illustrations of features of an example interface of a computing device.

FIG. 5 is a block diagram of another example method for determining estimate information.

FIG. 6 is a flow chart of an example method for determining repair cost information for a particular repair shop.

FIG. 7 is a flow chart of an example method for determining a range of repair costs.

FIG. 8 is a flow chart of an example method for determining one or more future vehicle services.

FIG. 9 is a functional block diagram illustrating an example computing device used in a computing system that is arranged in accordance with at least some embodiments described herein.

FIG. 10 is a schematic illustrating a conceptual partial view of an example computer program product that includes a computer program for executing a computer process on a computing device, arranged according to at least some embodiments described herein.

### DETAILED DESCRIPTION

The following detailed description describes various features and functions of the disclosed systems and methods with reference to the accompanying figures. In the figures, similar reference numbers identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

The example embodiments are applicable to a variety of repairable items, such as a vehicle or some other type of repairable item. For purposes of this description, a vehicle can comprise an automobile, a motorcycle, a semi-tractor, a light-duty truck, a medium-duty truck, a heavy-duty truck, a farm machine, a boat or ship, a generator, an airplane, an oil-drilling rig, or some other type of vehicle. A vehicle can include or use any appropriate voltage or current source, such as a battery, an alternator, a fuel cell, a capacitor, and the like, providing any appropriate current and/or voltage, such as about 12 volts, about 42 volts, and the like. A vehicle can include or use any desired system or engine. Those systems or engines can comprise items that use fossil fuels, such as gasoline, natural gas, propane, and the like, electricity, such as that generated by a battery, magneto, fuel cell, solar cell and the like, wind and hybrids or combinations thereof.

This disclosure discloses, among other things, methods and devices for determining estimate information related to at least one potential vehicle fix for a vehicle based on vehicle information and content of a vehicle repair database. In some instances, the vehicle repair database can include data gathered from multiple repair shops regarding repairs performed on various vehicles by the multiple repair shops. For example, the data of the vehicle repair database can be used to determine estimates of possible problems with a vehicle and associated charges that could result based on historical failure data for particular vehicles or vehicle types.

According to an example method, a computing device can receive vehicle information that includes a vehicle identifier and vehicle-usage data for a vehicle. In one embodiment, the computing device can be a computing device in a server that is configured to communicate with a client computing device via a communication network. The vehicle information can be a year, make, and model (YMM) of the vehicle or a vehicle identification number (VIN). A VIN may include a build date, build site, engine type, or other information about a vehicle. The vehicle information can also include other types of information that differentiates different models or types of vehicles, such as regular production option (RPO) codes that refer to a specific option or modification to a vehicle. For example, the vehicle information may indicate that a vehicle includes a trailer hauling package or various other components that a vehicle can be manufactured or equipped with.

The vehicle-usage data may be data that is indicative of how much the vehicle has been used. Vehicle use is typically measured in either miles or kilometers driven or hours of operation. For instance, if the vehicle is an automobile or truck, the vehicle-usage data may be an odometer reading that indicates a number of miles driven by the vehicle. In another instance, the vehicle may be a boat, aircraft, generator, oil-drilling rig and the vehicle-usage data may be an hour meter reading that indicates a number of hours of operation. Thus, the vehicle-usage data may provide an indication of vehicle usage. Other examples of vehicle-usage data may also exist. Although portions of this disclosure are described with respect to an odometer reading or mileage of a vehicle, the examples are not meant to be limiting.

Additionally, in some examples, the vehicle information can include symptom information describing a condition of the vehicle. As an example, the symptom information can be “engine hesitates on takeoff” or “engine is overheating”. In other examples, the vehicle information can include one or more diagnostic trouble codes (DTCs). A DTC may be a generic or manufacturer-specific code that is used to identify vehicle problems, such as “Throttle/Petal Position Sensor/Switch Malfunction” or “Transmission Control System Malfunction”. In still other examples, the vehicle information can include an indication that a malfunction indicator lamp of the vehicle is illuminated. Other examples may also exist.

Based on the vehicle information, the computing device can determine repair information of a vehicle repair database relating to the vehicle. The repair information can include at least one potential vehicle fix to a given malfunction. In one example, the repair information can include one or more of the most frequently performed vehicle fixes for the vehicle within a range of the mileage of the vehicle. For instance, if the vehicle is a Toyota Tundra that has 47,000 miles, the repair information can include the ten most frequently performed vehicle fixes for Toyota Tundras having between 40,000 and 55,000 miles. Other examples are possible, and the example is not meant to be limiting.

In an instance in which the vehicle information includes symptom information or a DTC, the repair information can also include a successful fix percentage associated with the symptom information or DTC. For instance, the successful fix percentage can indicate a percentage of similar vehicles with the same or similar symptom information that were successfully fixed by performing the at least one potential vehicle fix to the similar vehicles.

The computing device can also determine estimate information related to the at least one potential vehicle fix. Such estimate information can include a repair time and/or repair cost, for example. A repair cost may be a cost to perform a vehicle fix. That is, the repair cost may be a cost that is charged to a customer to perform the vehicle fix. As such, the repair cost can include a labor cost, and can also include a cost of one or more parts, as well as any other costs associated with performing the repair. The estimate information can also be provided to a communication network such that the estimate information can be provided to another computing device (e.g., a client computing device of a repair shop).

In some examples, the estimate information can enable a service writer to prepare an estimate for the at least one vehicle service. If the repair information identifies multiple vehicle fixes, the service writer can use estimate information related to each of the vehicle fixes to request preapproval from a vehicle owner for one or more of multiple possible repairs. For instance, when a vehicle owner brings the vehicle to the repair shop, the service writer can request approval from a vehicle owner to perform one or more repairs if a technician determines that the vehicle requires one of the repairs.

Similarly, the example method can allow a service writer to provide an estimate to a vehicle owner and seek preapproval for one or more repairs before the vehicle is brought to the repair shop (e.g., over the phone, via a webpage, via a web-based application, etc.). In one example, if a vehicle owner is given direct access to the web-based application, the estimate information provided to vehicle owner via the web-based application may identify an estimated repair cost and/or repair time without identifying the particular vehicle service that may need to be performed.

As mentioned above, this description describes several example embodiments. Within this description, the articles “a” or “an” are used to introduce elements of the example embodiments. The intent of using those articles is that there is one or more of the elements. The intent of using the conjunction “or” within a described list of at least two terms is to indicate any of the listed terms or any combination of the listed terms. The use of ordinal numbers such as “first,” “second,” “third” and so on is to distinguish respective elements rather than to denote a particular order of those elements. The ordinal numbers can be written in the form of 1st, 2nd, 3rd, and so on.

Additional functionalities and examples of the described methods and computing devices are also described hereinafter with reference to the accompanying figures.

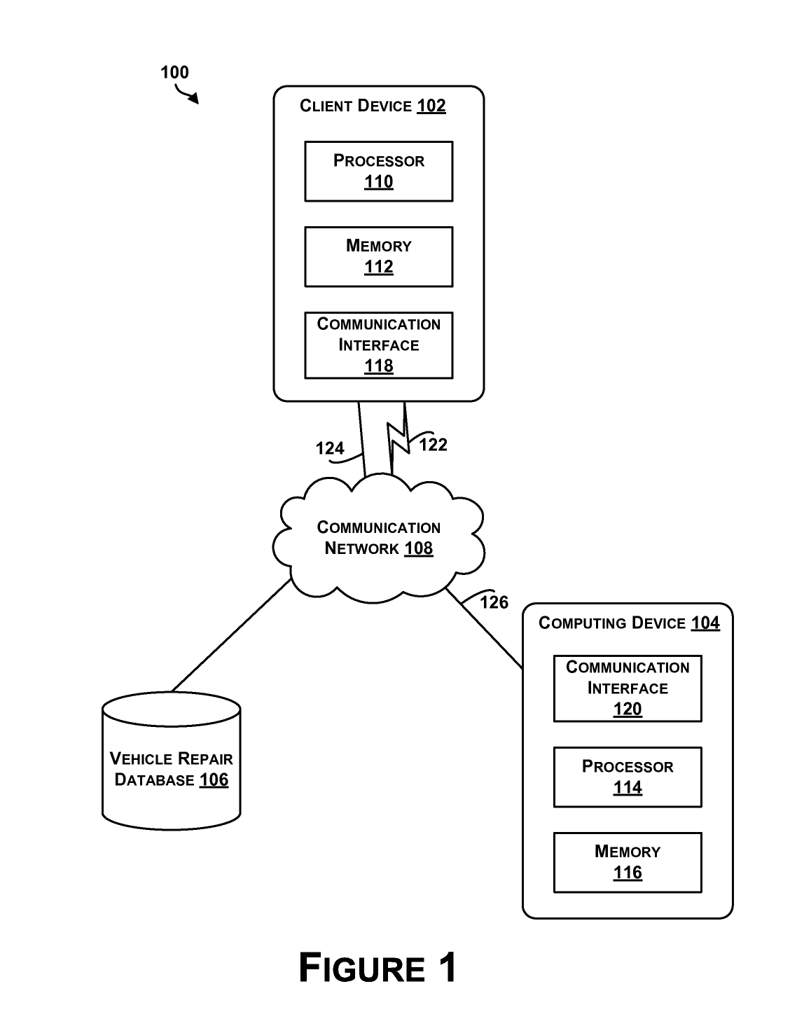

Referring now to the Figures, FIG. 1 illustrates an example system 100. As shown in FIG. 1, the example system 100 includes a client device 102, a computing device 104, a vehicle repair database 106, and a communication network 108. The client device 102 can represent any type of mobile or stationary computing device. By way of example, the client device 102 can be a computer that is located at a repair shop. However, the example is not meant to be limiting. In other instances, the client device 102 can be a laptop computer, tablet, cellular phone, wearable computing device, or other type of computing device.

The computing device 104 can similarly be any type of computing device. In one instance, the computing device 104 can be a server or a component of a server that is located remotely from the client device 102 (e.g., in a cloud computing environment). For example, the computing device 104 can be a desktop computer, workstation, or other type of computing device configured to operate within a client-server architecture. In another instance, the computing device 104 can be a computing device that is located at a repair shop. For example, the computing device 104 may be a computing device used by a repair shop to manage repair orders or shop equipment that is used to diagnose and service vehicles. Other configurations are also contemplated.

The client device 102 can include a processor 110 and a memory 112. Similarly, the computing device 104 can also include a processor 114 and a memory 116. The processor 110 and the processor 114 can be any type of processors, such as a microprocessor, digital signal processor, multicore processor, etc., coupled to the memory 112 and memory 116 respectively. The memory 112 and the memory 116 can be any type of memories, such as volatile memory like random access memory (RAM), dynamic random access memory (DRAM), static random access memory (SRAM), or non-volatile memory like read-only memory (ROM), flash memory, magnetic or optical disks, digital versatile disk read-only memory (DVD-ROM), or compact-disc read-only memory (CD-ROM), among other devices used to store data or programs on a temporary or permanent basis.

Additionally, the client device 102 can include a communication interface 118 and the computing device 104 can include a communication interface 120. The communication interface 118 and the communication interface 120 can facilitate communication with the communication network 108 for the client device 102 and the computing device 104 according to one or more wired or wireless communication standards. For instance, the communication interface 118 and the communication 120 can facilitate data communication via network links 122, 124, and 126. The communication interface 118 and the communication interface 120 can include a transmitter to transmit data and a receiver to receive data. Alternatively, the communication interface 118 and the communication interface 120 can include a transceiver configured to transmit and receive data.

The vehicle repair database 106 can be or include a data storage device, such as a non-transitory computer-readable storage device. Although the vehicle repair database is shown connected to the computing device 104 via the communication network 108, in another embodiment, the vehicle repair database 106 can be directly connected to or a component of the computing device 104 (not shown). The vehicle repair database 106 can store a plurality of repair orders. Each repair order can include information pertaining to repairing a vehicle. Additionally or alternatively, each repair order can include other information such as information pertaining to performing preventative maintenance to a vehicle. The repair order can be created in an electronic format or can be prepared in paper format and manually entered into a computer or converted (e.g., scanned) to an electronic format. Text of a scanned repair order can also be recognized using optical character recognition (OCR) techniques. In some examples, a repair order can be arranged as a structured query language (SQL) file. Alternatively or additionally, a repair order can be arranged as an extensible markup language (XML) file.

By way of example, a repair order can include a combination of any of a service provider identifier, a date of service identifier, a customer identifier that indicates a customer seeking service of a given vehicle, vehicle information that indicates the given vehicle, a service request indicating the complaint or service requested by the customer, parts information indicating parts obtained for servicing the given vehicle, and service procedure information carried out on the given vehicle.

A service provider identifier can include, for example, information that indicates a name and geographic location of the service provider. Vehicle information can include a VIN associated with the given vehicle, a YMM of the vehicle a year, make model, and engine of the vehicle (YMME), or a year, make, model, engine, and system (YMMES) of the vehicle. Service procedure information can include labor operation codes (LOCs) that refer to a particular operation performed to the given vehicle. The LOCs can conform to those defined by a vehicle manufacturer, a service provider that generates a repair order, a service information provider, such as Mitchell Repair Information, LLC, Poway, Calif., or some other entity. The service procedure information can also identify a total cost for the service. Similarly, the parts information can include a part description, part number, and/or pricing information identifying any parts associated with the repair order.

In one embodiment, repair orders can be stored in local computing systems of repair shops and can be backed up and transmitted to the vehicle repair database 106 on a frequent basis (e.g., hourly, daily, weekly, etc.). When a request for estimate information is received, the computing device 104 can search the repair orders of the vehicle repair database 106. In some instances, the vehicle repair database 106 can also store search queries and associated search results from prior searches to facilitate quickly retrieving information from the vehicle repair database 106. For instance, the computing device 104 can be configured to access a list of prior searches before searching the entire vehicle repair database 106 to identify whether search results are already stored by the vehicle repair database 106 for a given search. The stored search results may also be updated on a periodic basis by the vehicle repair database 106. For example, when the vehicle repair database 106 is updated with new repair orders, the computing device 104 or a separate computing device may re-search the vehicle repair database 106 to update the stored search results.

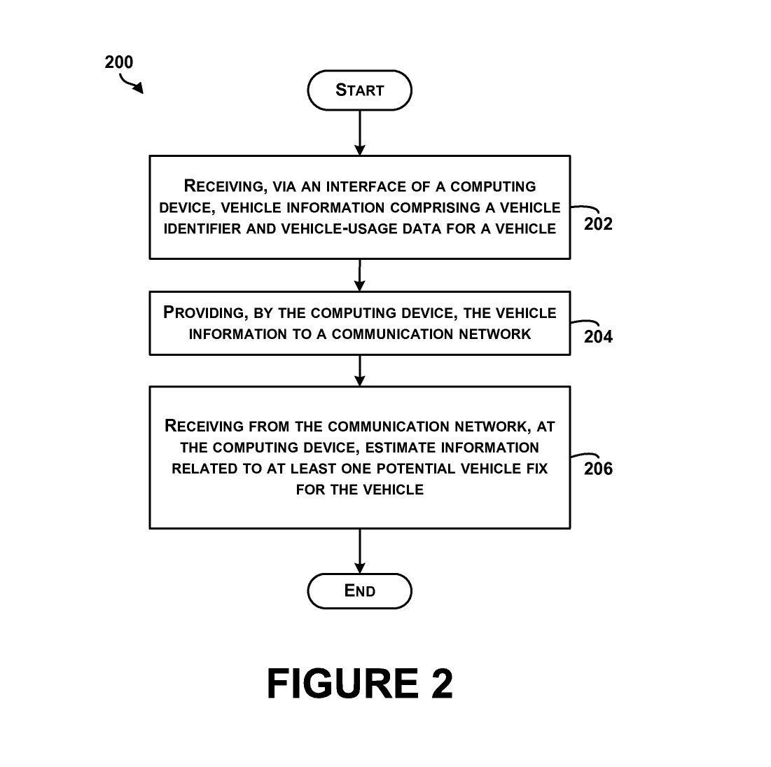

As discussed briefly above, data of the vehicle repair database can be used by a service writer of a repair shop to facilitate estimating the cost and/or time to perform services. Turning now to FIG. 2, FIG. 2 is a block diagram of an example method 200 for determining estimate information. Method 200 shown in FIG. 2 presents an embodiment of a method that could be used or implemented by the client device 102 of FIG. 1, for example, or by components of the client device 102 of FIG. 1, or more generally by any of a variety of computing devices. Method 200 can include one or more operations, functions, or actions as illustrated by one or more of blocks 202-206. Although the blocks are illustrated in a sequential order, these blocks can also be performed in parallel, and/or in a different order than those described herein. Also, the various blocks can be combined into fewer blocks, divided into additional blocks, and/or removed based upon the desired implementation.

In addition, for the method 200 and other processes and methods disclosed herein, the block diagram shows functionality and operation of one possible implementation of present embodiments. In this regard, each block can represent a module, a segment, or a portion of program code, which includes one or more instructions executable by a processor or computing device for implementing specific logical functions or steps in the process. The program code can be stored on any type of computer-readable medium, for example, such as a storage device including a disk or hard drive. The computer-readable medium can include non-transitory computer-readable medium, for example, such as computer-readable media that stores data for short periods of time like register memory, processor cache and random access memory (RAM). The computer-readable medium can also include non-transitory media, such as secondary or persistent long term storage, like read only memory (ROM), optical or magnetic disks, compact-disc read only memory (CD-ROM), for example. The computer-readable medium can also be any other volatile or non-volatile storage systems. The computer-readable medium can be considered a computer-readable storage medium, for example, or a tangible storage device.

In addition, for the method 200 and other processes and methods disclosed herein, each block in FIG. 2 can represent circuitry that is wired to perform the specific logical functions in the process.

Initially, at block 202, the method 200 includes receiving, via an interface of a computing device, vehicle information comprising a vehicle identifier and vehicle-usage data for a vehicle. In one instance, a service writer or vehicle owner can manually input the vehicle identifier and an odometer reading by keying in or otherwise selecting the vehicle identifier and odometer reading via a user interface of the computing device. In another instance, a service writer or vehicle owner can manually input the vehicle identifier and an hour meter reading using the user interface of the computing device. Alternatively, the computing device may request the vehicle information, or a portion of the vehicle information, from an electric control unit of the vehicle by way of a wired or wireless vehicle data bus. In another example, the computing device may receive a vehicle diagnostic report (e.g., an email) from a remote diagnostics system of a vehicle (e.g., OnStar or another source). The computing device can then automatically parse the email to determine the vehicle information. The vehicle identifier can identify a particular vehicle. For instance, the vehicle identifier can be a VIN. In another example, the vehicle identifier can identify a particular vehicle type. For instance, the vehicle identifier can include a YMM, YMME, or YMMES.

The vehicle information may also include symptom information describing a condition of the vehicle. The symptom information can identify a condition of the vehicle as reported by a customer, for example. As an example, the symptom information can indicate a symptom that is exhibited by the vehicle and/or reported by a vehicle owner such as “engine hesitates on takeoff”, “rough engine idle”, “engine cranks but won't start”, “poor gas mileage”, or “check engine light is on”. A check engine light can also be referred to as a malfunction indicator lamp that, when illuminated on an instrument panel of a vehicle, indicates a malfunction of a computerized engine management system of the vehicle. Alternatively or in addition, the vehicle information may include one or more DTCs and/or an indication that a malfunction indicator lamp of the vehicle is illuminated.

At block 204, the method 200 includes providing, by the computing device, the vehicle information to a communication network. In one example, upon receiving data indicating a request to determine estimate information related to one or more potential repair services, the computing device can provide the vehicle information to another computing device (e.g., a server) by way of the communication network. For instance, a service writer can click or otherwise select an icon, press a button or key, or otherwise trigger a request to retrieve estimate information. The computing device can then generate a request for estimate information based on the vehicle information provided via the interface. The request can then be transmitted by a communication interface of the computing device to the communication network.

At block 206, the method 200 includes receiving from the communication network, at the computing device, estimate information related to at least one potential vehicle fix for the vehicle. In one example, in response to providing the vehicle information to the communication network, the computing device can receive the estimate information. The estimate information related to the at least one potential vehicle fix can include a repair time and/or repair cost. In an embodiment in which a vehicle owner is requesting the estimate information directly (e.g., via a web-based application), the estimate information may identify the repair time and/or repair cost without identifying the potential vehicle fix. As discussed above, the repair cost may include any costs associated with performing the at least one potential vehicle fix, such as labor costs and part costs. In an embodiment, in which the vehicle information includes symptom information, the estimate information related to the at least one potential vehicle fix can include a successful fix percentage associated with the symptom information.

Additionally or alternatively, the estimate information can include a range of repair costs for the at least one potential vehicle fix. For instance, the range of repair costs can indicate repair costs of service repairs that have recently been performed by competitors of a particular repair shop (e.g., repair shops within a predetermined geographical area of a location of the particular repair shop). In such an instance, the particular repair shop can be identified based on an identity of the computing device that provided the vehicle information. For instance, the computing device can be registered with an entity that provides the estimate information such that the location of the particular repair shop is known.

In some examples, the method 200 can further include providing the estimate information for display via the interface of the computing device. For instance, the estimate information can be provided for display to assist a service writer in preparing an estimate for a vehicle owner. In that regard, client device 102 of FIG. 1 can include a display and a user interface (not shown).

In another example, the method 200 can further include providing the estimate for display via a display of a vehicle. For instance, if the vehicle information is received by the computing device from a remote diagnostics system of the vehicle, the estimate information may be provided, via the communication network, to the remote diagnostics system for display within the vehicle.

In other examples, the method 200 can also include receiving from the communication network estimate information related to at least one future vehicle service for the vehicle. In some instances, estimate information related to a future vehicle service(s) can assist a service writer in preparing a maintenance plan with a vehicle owner. The estimate information related to the future vehicle service can also include a repair cost and/or repair time. The future vehicle service(s) can be determined based on failure trends of vehicles which are functionally similar to the vehicle.

In some instances, functionally similar vehicles can be vehicles that are of a particular vehicle type (e.g., the same YMM, YMME, or YMMES). As an example, if the vehicle is a 2007 Chevy Cobalt that has 75,000 miles, a future vehicle service can be repairing/replacing timing chain guides. Such a service can be noted, for instance, because data of a vehicle repair database indicates that timing chain guides usually wear out between 85,000 and 90,000 miles for 2007 Chevy Cobalts. In other examples, functionally similar vehicles can be vehicles that have the same engine or powertrain. Examples of functionally similar vehicles can also include vehicles that are sister vehicles such as a 2008 Ford Explorer and a 2008 Mercury Mountaineer, or a 2002 Chevy Camaro and a 2002 Pontiac Firebird, etc.

In further examples, the method 200 can also include receiving from the communication network estimate information associated with one or more related parts or services. For instance, if the estimate information identifies a potential vehicle fix that involves removing and replacing a particular part of the vehicle, the estimate information may also include information identifying one or more parts and/or services that are related to the particular part. As an example, the related parts may be parts that are of the same system of the vehicle as the particular part or parts that are connected to the particular part. For instance, the particular part may be a water pump and the related parts may include a water hose.

As another example, the related services may be services that may be performed more efficiently when performed in conjunction with the potential vehicle fix than when performed individually. For instance, if the potential vehicle fix is replacing a water pump that involves removing one or more components of the vehicle to access the water pump, a related service may be replacing a timing belt that also involves removing the same components of the vehicle. In some cases, the estimate information received from the communication network may include a cost comparison that indicates a cost of performing the related service in conjunction with the potential vehicle fix and a cost of performing the related service independently of the potential vehicle fix (e.g., during a separate repair to be performed at a later date). That is, the computing device may receive data from the communication network that is indicative of: a repair cost associated with performing the potential vehicle fix and the related service during a single repair; and a repair cost associated with performing the potential vehicle fix and the related service during separate repairs.

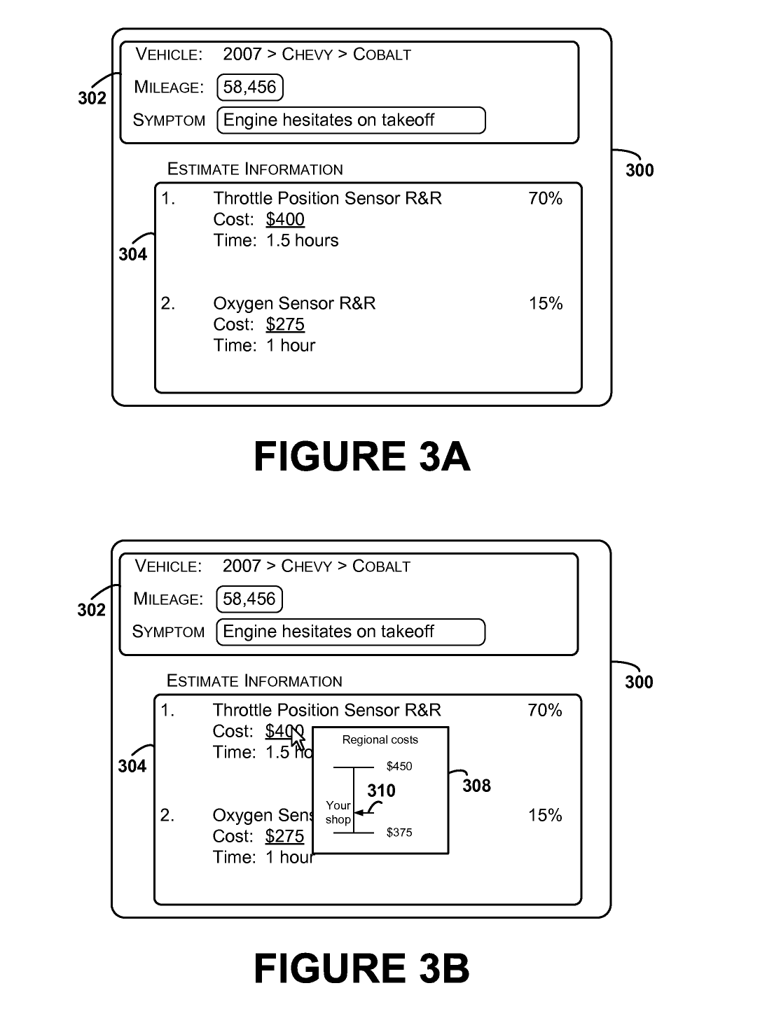

FIGS. 3A and 3B are conceptual illustrations of features of an example interface 300 of a computing device. For instance, the example interface 300 can be an interface of a computing device that is performing the method 200 of FIG. 2. In one example, the interface 300 can be a web-based interface that is provided within a webpage. In another example, the interface 300 can be an application interface of an application executing on a computing device.

In one instance, a service writer can specify vehicle information 302 via the interface 300. By way of example, the interface 300 displays vehicle information 302 that includes a vehicle identifier (2007 Chevy Cobalt), mileage (58,456), and symptom (engine hesitates on takeoff). In response to requesting estimate information related to the vehicle information 302, estimate information 304 can be received and provided for display via the interface 300.

As shown in FIG. 3A, the estimate information 304 can include one or more potential vehicle fixes for the vehicle. In the example of FIG. 3A, two potential vehicle fixes are shown: Throttle Position Sensor R&R and Oxygen Sensor R&R. R&R can refer to remove and replace. For each of the potential vehicle fixes, a repair cost and repair time are provided.

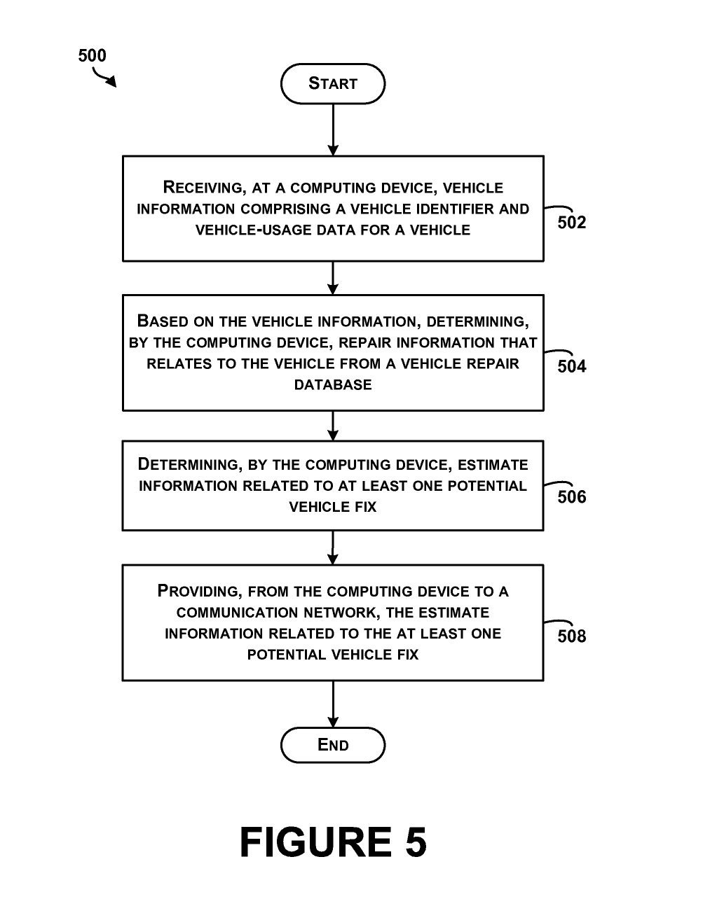

As further shown in FIG. 3A, in some examples, estimate information can include a successful fix percentage corresponding to each potential vehicle fix. By way of example, the Throttle Position Sensor R&R is indicated to have a successful fix percentage of 70%. In one instance, a successful fix percentage of 70% can be interpreted by a service writer to mean that out of all known 2007 Chevy Cobalts having around 58,000 miles and exhibiting a symptom of engine hesitating on takeoff, the symptom was successfully resolved by performing the Throttle Position Sensor R&R service. Further information about the successful fix percentages is described below with reference to FIG. 5.

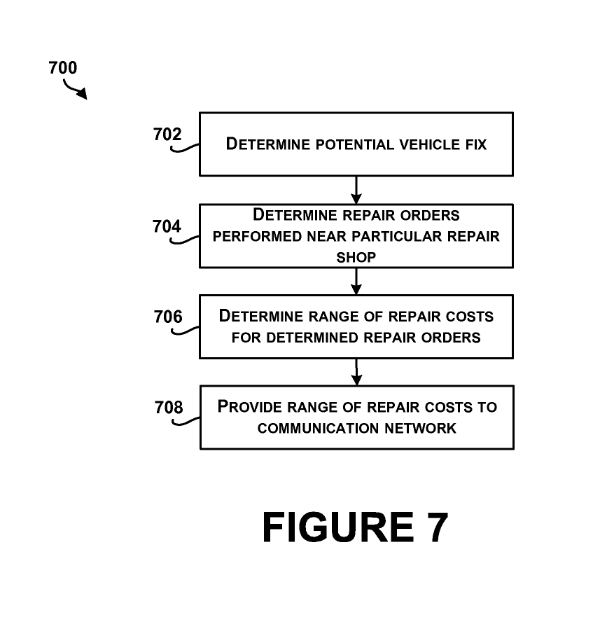

As shown in FIG. 3B, according to one example embodiment, when a user hovers over or otherwise selects a repair cost for a vehicle fix, a range of repair costs 308 can be provided for display via the interface 300. An example method for determining a range of repair costs that can be executed by the computing device 104 of FIG. 1, for example, is further described below with reference to FIG. 7. In the example shown in FIG. 3B, when a user hovers a pointer over the cost of the Throttle Position Sensor R&R service, a range of repair costs is displayed. In one instance, the range of repair costs can be determined based on costs that repair shops within a predetermined range of a geographic location of a particular repair shop have reported for performing the service on 2007 Chevy Cobalts. In another instance, the range of repair costs can be determined based on costs that repair shops across an entire country have reported for performing the service on 2007 Chevy Cobalts.

Additionally, an indicator 310, which illustrates how an estimate for performing a particular repair at a particular repair shop compares to prices that customers paid at other repair shops, can also be provided for display via the interface 300. The other repair shops may be repair shops within a predetermined range of a geographic location of the particular repair shop, for instance.

Other implementations are also possible, and the example shown in FIG. 3B is not meant to be limiting. Although the range of repair costs 308 is illustrated as a graphic overlaying the interface 300, in other instances, a range of repair costs can be provided adjacent to the estimate information 304 (e.g., beside, above, below) or provided in a separate display window.

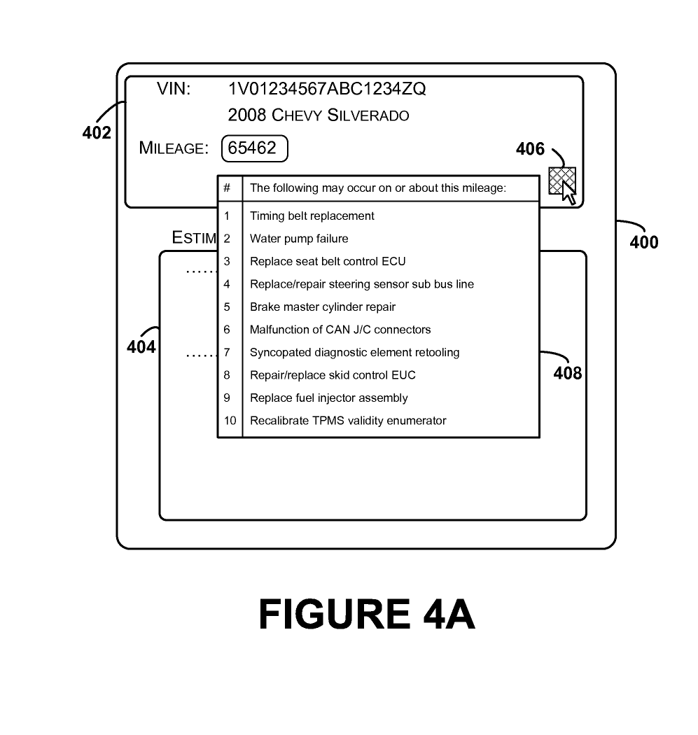

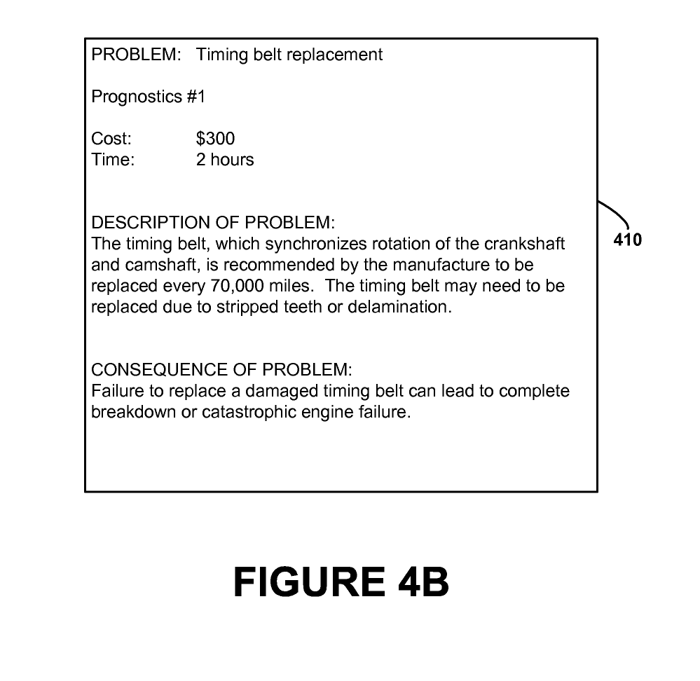

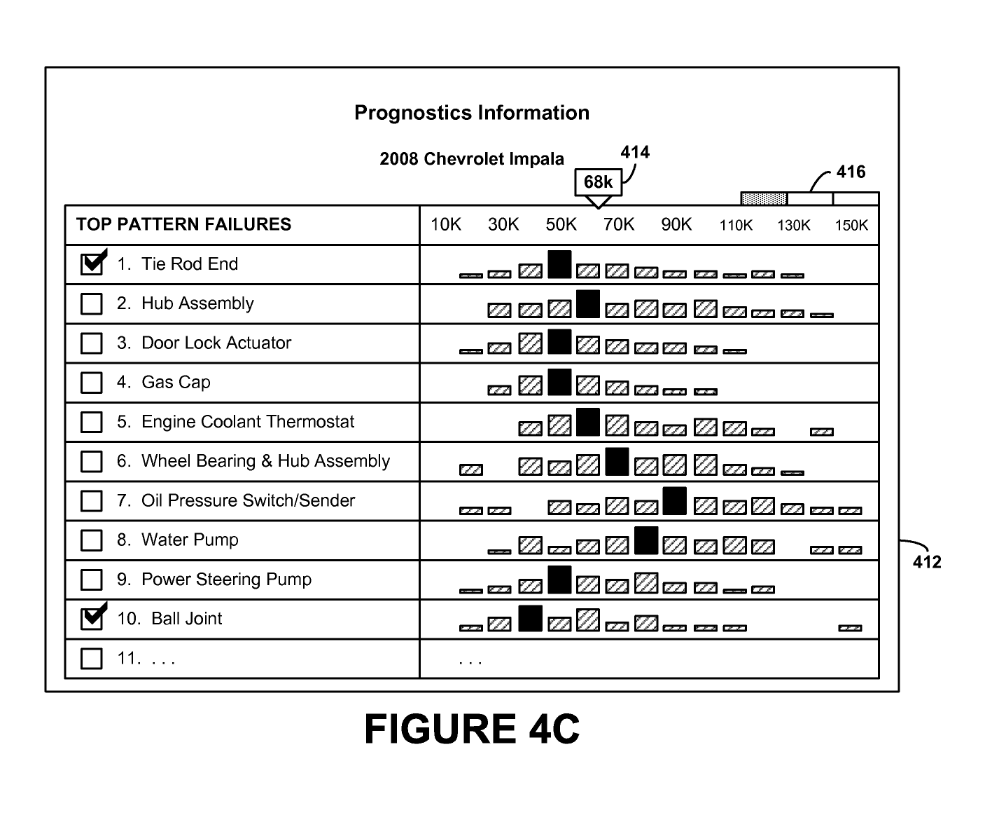

FIGS. 4A-4C are conceptual illustrations of features of another example interface 400 of a computing device. In one instance, the interface 400 can be an interface of a computing device that is performing the method 200 of FIG. 2. As shown in FIG. 4A, a service writer can specify vehicle information 402 via the interface 400. By way of example, the vehicle information 402 illustrated in FIG. 4A includes a vehicle identifier (VIN) and mileage (65462). Note that the YMM of the vehicle can be automatically determined by decoding the VIN using the client device 102. Estimate information 404 is also provided for display via the interface 400.

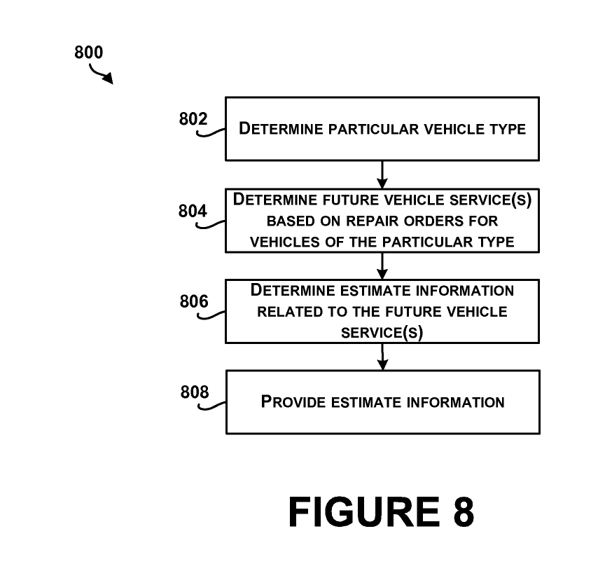

Additionally, the interface 400 shown in FIG. 4A illustrates a feature that can allow a service writer to determine information about future vehicle services to the vehicle. In one case, when a user hovers over or otherwise selects a prognostics icon 406 of the interface 400, vehicle-usage-related problems for the type of vehicle specified are shown in a prognostics window 408. For example, the prognostics window 408 displays a list of future vehicle services that have been reported for 2008 Chevy Silverados having about or around 65,000 miles. In one example, the vehicle services of the prognostics window 408 are displayed in ascending order by frequency. For instance, “Timing belt replacement” can be the service that has been reported to have been performed most often while “Recalibrate TPMS (tire pressure monitoring system) validity enumerator” can be the service that has been reported to have been performed the least often. An example method for determining future vehicle services is described below with reference to FIG. 8.

In some examples, the interface 400 can allow a user to click on or otherwise select a particular vehicle service to display more information about the particular vehicle service. By way of example, FIG. 4B illustrates a vehicle service description window 410 that can be provided via the interface 400 of FIG. 4A. In one instance, the vehicle service description window 410 can be provided in a window that overlays the interface 400. In other instances, the vehicle service description window 410 can be provided in a separate display window. The vehicle service description window 410 provides information related to the “Timing belt replacement” vehicle service, such as a repair cost, repair time, description of the problem, and consequence of the problem.

In some examples, the interface 400 may also allow a service writer to record a vehicle owner's comments about one or more of the future vehicle services. For example, if a vehicle owner indicates that they are interested in performing one or more of the future vehicle services in the future, a service writer can highlight or otherwise select the future vehicle service(s). The interface 400 may also generate a reminder that may trigger the service writer to remind the vehicle owner about the selected future vehicle service at a later date.

FIG. 4C shows another example prognostics window 412 that can be provided in response to a user selecting the prognostics icon 406 from the interface 400. Note that selecting the prognostics icon 406 is just one example of a method to cause an interface to provide the prognostics window 412. In other instances, the prognostics window 412 may be provided in response to a service writer inputting vehicle information that includes a vehicle identifier and vehicle-usage data.

The prognostics window 412 lists the top pattern failures for a vehicle (2008 Chevrolet Impala). The pattern failures can be sorted in order of most frequently reported pattern failures. Alternatively, the pattern failures can be sorted alphabetically. For each of the failures, a histogram is provided. The histogram can be determined based on vehicle-usage data collected from other repair orders of a vehicle repair database. For instance, a histogram for the “tie rod end” failure may be determined by identifying all repair orders of the vehicle repair database that involved repairing the tie rod end on a 2008 Chevrolet Impala and sorting the identified repair orders into bins based on reported odometer readings. In the example of FIG. 4C, each bin represents a 10,000 mile range. That is, a first bin is 0-10,000 miles, a second bin is 10,001-20,000 miles, a third bin is 20,001-30,000 miles, etc. In other examples, other increments may be used. The histograms can be normalized histograms. That is, the height of each bin may correspond to a percentage.

Additionally, a mode of each histogram is easily identifiable in the prognostics window 412. By way of example, the mode of each histogram is shown by a bin that is shaded. In practice, the mode of each histogram may be displayed in a different color than other bins of the histograms such that the mode is easily identifiable to a user. Further, as shown in FIG. 4C, a vehicle-usage indicator 414 can be displayed. The vehicle-usage indicator 414 indicates vehicle-usage data for a particular vehicle. In some embodiments, a user may choose one or more vehicle services to create an estimate for or add to an existing estimate based on a relationship between the vehicle-usage indicator and one or more modes of the histograms. For instance, since the histogram for the “ball joint” failure indicates that ball joints are usually repaired between 30,000 and 40,000 miles, a service writer may check a check-box next to the “ball joint” failure. In response to the service writer selecting the check-box, an estimate for repairing the ball joint may be determined. Alternatively, the estimate for repairing the ball joint may be added to an existing estimate.

In other examples, additional types of prognostics information can be provided. For instance, a user can select one or more tabs 416 to cause other prognostics information to be shown. By way of example, the additional prognostics information may include the top diagnostic trouble codes reported for a particular vehicle type or the top symptoms reported for a particular vehicle type. The other prognostics information can also be graphically represented using histograms similar to the histograms shown in FIG. 4C. Other examples are also contemplated.

Turning now to FIG. 5, FIG. 5 is a block diagram of another example method 500 for determining estimate information. Method 500 shown in FIG. 5 presents an embodiment of a method that could be used or implemented by the computing device 104 of FIG. 1, for example, or by components of the computing device 104 of FIG. 1, or more generally by any of a variety of computing devices. Method 500 can include one or more operations, functions, or actions as illustrated by one or more of blocks 502-508. Although the blocks are illustrated in a sequential order, these blocks can also be performed in parallel, and/or in a different order than those described herein. Also, the various blocks can be combined into fewer blocks, divided into additional blocks, and/or removed based upon the desired implementation. Each block can represent a module, a segment, or a portion of program code, which includes one or more instructions executable by a processor for implementing specific logical functions or steps in the processor. In addition, each block in FIG. 5 can represent circuitry that is wired to perform specific logical functions in the process.

Initially, at block 502, the method 500 includes receiving, at a computing device, vehicle information comprising a vehicle identifier and vehicle-usage data for a vehicle. In one instance, the computing device can be a server that receives data indicating the vehicle information from a client computing device (e.g., a computing device at a repair shop).

In one example, the vehicle identifier can identify a particular vehicle. For instance, the vehicle identifier can be a VIN. In another example, the vehicle identifier can identify a particular vehicle type. For instance, the vehicle identifier can include a YMM, YMME, or YMMES. The vehicle-usage data can be an odometer reading or an hour meter reading, for example.

The vehicle information can also include or accompany symptom information. Alternatively, the symptom information can be transmitted or received separate from the vehicle information. The symptom information can identify a condition of the vehicle as reported by a customer, for example. As an example, the symptom information can indicate a symptom that is exhibited by the vehicle and/or reported by a vehicle owner such as “engine hesitates on takeoff”, “poor acceleration”, etc. In some instances, the vehicle information can further include one or more DTCs or information identifying that a malfunction lamp indicator of the vehicle is illuminated.

In some examples, the computing device can also receive repair shop information identifying a particular repair shop. For instance, if a service writer sends the vehicle information to the computing device from a client computing device at a particular repair shop, information identifying the particular repair shop and/or the client computing device of the particular repair shop can also be provided. The repair shop information can include a unique repair shop ID, repair shop name, client computing device ID, etc. The computing device can use the repair shop information to facilitate providing estimate information to the client computing device. The computing device can also use the repair shop information to facilitate determining customized estimate information.

At block 504, the method 500 includes based on the vehicle information, determining, by the computing device, repair information that relates to the vehicle from a vehicle repair database. As described above, the vehicle repair database can store a plurality of repair orders that each include information pertaining to repairing a vehicle and/or preforming preventative maintenance. By way of example, a repair order can include a combination of any of a service provider identifier, a date of service identifier, a customer indicator that indicates a customer seeking service of a given vehicle, vehicle information that indicates the given vehicle, a service request indicating the complaint or service requested by the customer, parts information indicating parts obtained for servicing the given vehicle, and service procedure information carried out on the given vehicle. In one embodiment, repair orders can be stored in local computing systems of repair shops and can be backed up and transmitted to the vehicle repair database on a frequent basis (e.g., hourly, daily, weekly, etc.).

In one example, the computing device can be configured to match the vehicle information with content of the vehicle repair database so as to identify repair orders relating to the vehicle information. Matching the received vehicle information to repair orders of the vehicle repair database can include searching or querying the vehicle repair database to correlate the vehicle identifier, mileage, DTCs, and/or symptom information with content of repair orders of the vehicle repair database. In one instance, a combination of YMM, YMME, or YMMES and mileage can be used to filter repair orders of the vehicle repair database. Subsequently, the identified repair orders can be further filtered based on keywords of the symptom information matching keywords of the identified repair orders or based on one or more DTCs. The vehicle repair database can also be configured or arranged to facilitate matching the received vehicle information to one or more repair orders.

In an example in which the computing device also receives repair shop information, the content of the vehicle repair database can also optionally be filtered based on a geographic location of a particular repair shop that provides the vehicle information. For example, the computing device can be configured to identify repair orders matching the vehicle information and associated with repair shops that are located within a predetermined geographical range of the particular repair shop (e.g., within 25 miles, 100 miles, etc.) or located within the same city as the particular repair shop.

Based on content of the vehicle repair database matching the vehicle information, the computing device can determine the repair information. The repair information can include at least one potential vehicle fix to a given malfunction. In one example, to determine the potential vehicle fix(es), the computing device can identify repair orders of the vehicle repair database that match the vehicle information, and identify the service performed according to each repair order. The computing device can then determine, from among the identified repair orders, the most frequently performed services. In another example, the vehicle repair database may store predetermined repair information that is organized by vehicle information. To determine the repair information, the computing device can perform a data-lookup keyed to the vehicle information. For instance, given a vehicle identifier and mileage of a particular vehicle, the computing device can retrieve from the vehicle repair data base a list of predetermined repair information for the particular vehicle. By way of example, the predetermined repair information may identify the most frequently performed services for the particular vehicle (e.g., the top ten most frequently performed services, the top five most frequently performed services, etc.). In other examples, the predetermined repair information may identify any services for the particular vehicle that have been performed more than a predetermined number of times (e.g., any services that have been performed more than fifty times, any services that have been performed more than one hundred times, etc.).

In some examples, the repair information can also include a successful fix percentage associated with symptom information. In one instance, the successful fix percentage associated with a particular vehicle fix can be determined based on the number of similar vehicles reporting the symptom information that were successfully fixed by the particular vehicle service. For example, if the vehicle information is a 2007 Chevy Cobalt having 50,000 miles and a symptom of “engine hesitates on takeoff”, the computing device can identify one hundred repair orders for 2007 Chevy Cobalt's having between 40,000 and 60,000 miles and a symptom similar to “engine hesitates on takeoff”. The computing device can also determine that of the one hundred identified repair orders, seventy of the repair orders indicate that the throttle position sensor was replaced. The successful fix percentage provided for the throttle position sensor R&R service can therefore be 70%. In some instances, if the computing device is unable to identify more than a threshold number of repair orders corresponding to a mileage of the vehicle, the mileage range may be expanded or even not used as a filtering term.

At block 506, the method 500 includes determining, by the computing device, estimate information related to at least one potential vehicle fix. In one example, the computing device can estimate a repair time and/or repair cost associated with any of the potential vehicle fixes that have been determined. The repair cost may include any costs associated with performing the at least one potential vehicle fix. In one instance, the computing device can determine a repair time for a potential vehicle fix based on a database of service labor time standards. The database of service labor time standards can include benchmarks for time required to perform various vehicle services/repairs.

In some examples, the computing device can estimate a repair cost by multiplying an estimated repair time (e.g., a benchmark repair time) by a shop labor rate. The shop labor rate can be a labor rate of a particular repair shop. For example, if the computing device receives or otherwise determines repair shop information, the computing device can identify a shop labor rate for the particular repair shop. The computing device can select the labor rate from a plurality of rates the particular repair shop uses (e.g., normal hours rate, after hours rate, holiday rate, weekend rate, senior citizen rate, etc.). In one instance, the computing device can receive an indication of which labor rate to use along with the repair shop information. For example, the computing device may receive data identifying which labor rate to use when receiving the repair shop information, and based on the data, identify the appropriate labor rate. Additional costs such as costs for parts or disposal of materials can also be factored into the repair cost. To determine the cost of parts or disposal of materials, the computing device can access one or more electronic parts catalogs (EPCs) or access a table in the vehicle repair database that stores information regarding prices for parts and disposal of materials.

In other examples, the vehicle repair database may store predetermined estimate information for a plurality of vehicle fixes, and the computing device can determine the estimate information by performing a data-lookup keyed to a potential vehicle fix.

In some examples, the computing device can also determine a range of repair costs for one or more of the potential vehicle fixes. For example, the computing device can determine a range of repair costs based on costs reported for a group of repair orders. In one example, the repair orders can be repair orders for repair shops that are in the same city as a particular repair shop or within a geographical range of the particular repair shop. This information can enable a service writer of the particular repair shop to see how an estimated repair cost compares to a price that competitor repair shops can charge for the same vehicle fix.

In other examples, the computing device can also determine the repair time based on a shop work load of a particular repair shop. For instance, the computing device may access a repair shop schedule to determine how many vehicles are currently being serviced and when the service for the vehicles is scheduled to be completed (such that a service technician would be available to perform the repair). Additionally or alternatively, the computing device may determine whether any parts required for the repair are available (based on an inventory of the repair shop). If one or more parts are unavailable, the computing device may incorporate an estimated shipping time for obtaining the unavailable parts into the estimated repair time. At block 508, the method 500 includes providing, from the computing device to a communication network, the estimate information related to the at least one potential vehicle fix. In one instance, the estimate information can be provided to a client computing device of a repair shop via the communication network, such that a service writer can prepare an estimate for a vehicle owner. For example, a service writer can use the estimate information to seek preapproval for performing one or more potential vehicle fixes if a service technician determines that a vehicle fix should be performed to resolve the symptom exhibited by the vehicle owner's vehicle.

In some examples, the computing device can also determine estimate information associated with replacing one or more parts that are related to a potential vehicle fix or performing services that are related to a potential vehicle fix. For instance, if the estimate information identifies a potential vehicle fix that involves removing and replacing a particular part of the vehicle, the computing device can also determine a repair time and/or repair cost of: removing and replacing one or more parts that are related to removing and replacing the particular part; and/or performing one or more related services that are related to removing and replacing the particular part.

As an example, the related part(s) may be part(s) that are of the same system of the vehicle as the particular part or parts that are connected to the particular part. As another example, the related service(s) may be service(s) that can be performed more efficiently when performed in conjunction with the potential vehicle fix than when performed individually. As yet another example, the related part(s) may be part(s) in proximity to the particular part. As yet another example, the related part(s) may be part(s) that are accessible for replacement without removing any other parts while accessing the particular part for replacement.

As yet another example, the related part(s) may be part(s) that are accessible for replacement after removing only a minimal number of additional parts while accessing the particular part for replacement. The minimal number of parts could, for example, be 1, 2, 3, 4, 5, 6, 7, 8 or some other number of parts. The computing device can be configured to select or the vehicle repair database may specify the minimal number of parts based on an amount of time specified for removing and replacing the particular part. In accordance with at least some example embodiments, the selected minimal number of parts is greater as the amount of time to remove and replace the particular part increases.

As yet another example, the related part(s) may be part(s) that are accessible for replacement by performing tasks that require less than a minimal amount of time while accessing the particular part for replacement. The minimal amounts of time used by the computing device could be based on tenths of hours, where each one tenth of an hour equals six minutes. The minimal amount of time could, for example, be 1, 2, 3, 4, 5, 6, 7, 8 or some other number of tenths of hours. The computing device can be configured to select or the vehicle repair database may specify the minimal number of tenths of hours based on an amount of time specified for removing and replacing the particular part. In accordance with at least some example embodiments, the selected minimal number of tenths of hours is greater as the amount of time to remove and replace the particular part increases.

In one example, the vehicle repair database may store information regarding parts and/or services that are related to vehicle fixes. To determine parts and/or services that are related to a particular vehicle fix, the computing device can perform a data-lookup keyed to the particular vehicle fix.

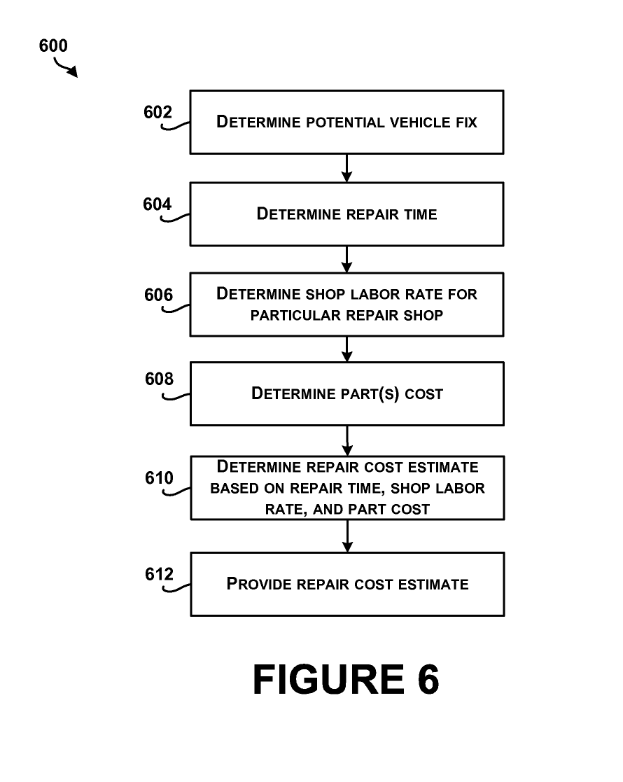

As described briefly above, in some examples, the computing device performing the method 500 can determine a repair cost estimate that is specific to a particular repair shop. FIG. 6 is a flow chart of an example method 600 for determining repair cost information for a particular repair shop. Each block of the method 600 can be carried out by a computing device, such as the computing device 104 of FIG. 1. As shown in FIG. 6, at block 602, a potential vehicle fix can be determined. Such a potential vehicle fix can be determined based on content of a vehicle repair database that matches vehicle information for a vehicle. Given the potential vehicle fix, at block 604, the computing device can determine a repair time for the potential vehicle fix. For instance, the computing device can access a database of service labor time standards to determine an appropriate repair time. As an example, the potential vehicle service can be “Replace mass air flow sensor” and the approved repair time for a service technician to replace the mass air flow sensor, according to service labor time standards, can be one and half hours.

Additionally, at block 606, a shop labor rate for the particular repair shop can be determined. In one example, the computing device can access a user account for the particular repair shop in a user account database. The user account can indicate the shop labor rate for the particular repair shop (e.g., 75$/hour).

Further, at block 608, a part cost for any parts associated with the potential vehicle fix may be determined. For instance, a cost of one or more parts (e.g., a cost of a mass air flow sensor for a particular vehicle) may be determined by querying one or more EPCs.

Subsequently, at block 610, to determine a repair cost estimate, the computing device can multiply the determined repair time by the determined shop labor rate to calculate a labor cost. The labor cost may then be combined with the part cost to determine the repair cost estimate. After the repair cost estimate has been determined, at block 612, the computing device can provide the repair data cost estimate to a client computing device via a communication network.

In other examples, as part of the method 500, the computing device can determine a customized range of repair costs for a particular repair shop. FIG. 7 is a flow chart of an example method 700 for determining a range of repair costs. Each block of the method 700 can be carried out by a computing device, such as the computing device 104 of FIG. 1. Initially, at block 702, the computing device can determine a potential vehicle fix. For example, a vehicle fix can be determined based on vehicle information received by the computing device and content of a vehicle repair database.

At block 704, the computing device can determine repair orders performed near a location of a particular repair shop. In one example, the computing device can receive repair shop information along with a request for estimate information related to a particular vehicle or vehicle type. Based on an identity and location of the particular repair shop, the computing device can identify repair orders for the potential vehicle fix that were performed at repair shops near a location of the particular repair shop. In one example, the other repair shops can be repair shops that are located in the same city as the particular repair shop. In another example, the other repair shops can be repair shops that are located within a predetermined range of the particular repair shop (e.g., 25 miles, 100 miles, a zipcode range, etc.).

After identifying repair orders associated with a potential vehicle fix that were performed near a particular repair shop, at block 706, the computing device can determine a range of repair costs. The computing device can determine the range of repair costs by identifying the maximum and minimum repair costs specified by the repair orders. The determined range of repair costs can then be provided to a client computing device via a communication network at block 708.

In still other examples, as part of the method 500, the computing device can also determine one or more future vehicle services that may need to be performed for a particular vehicle or vehicle type. FIG. 8 is a flow of an example method 800 for determining one or more future vehicle services. Each block of the method 800 can be carried out by a computing device, such as the computing device 104 of FIG. 1. As shown in FIG. 8, initially, at block 802, the computing device can determine a particular vehicle type. In one example, if the vehicle information received by the computing device is a VIN, the computing device can decode the VIN to determine a YMM, YMME, or YMMES. In other examples, the vehicle information can explicitly identify a YMM, YMME, or YMMES.

At block 804, the computing device can determine one or more future vehicle service(s) for the particular vehicle type based on repair orders for vehicles of the particular type and/or recommended services that are identified by a manufacturer. The repair orders can be data that represents failure trends for vehicles. For instance, the repair orders can indicate which parts of a particular vehicle type need to be repaired over time, and an average mileage or range of mileage when each part is repaired.

To determine the future vehicle service(s) the computing device can identify repair orders matching the particular vehicle type and performed within a range of miles of the odometer reading of a vehicle. To determine the range of miles, the computing device may subtract a predetermined number of miles from the mileage to determine a minimum and add a predetermined number of miles to the mileage to determine a maximum. If the odometer reading is 56,123 miles, for example, the range of miles can be 41,123 miles to 71,123 miles. Thus, the computing device can identify repair orders for the particular vehicle type with a reported mileage of between 41,123 miles and 71,123 miles. Alternatively, the computing device may identify which of a plurality of predetermined mileage ranges that the mileage corresponds to. For instance, if the predetermined ranges are 0 to 25,000 miles, 25,000 miles to 50,000 miles, 50,000 to 75,000 miles, and so on at 25,000 mile increments, the computing device may determine that the mileage range is 50,000 to 75,000 miles.

At block 806, the computing device can determine estimate information related to the one or more future vehicle services. The estimate information can include a repair time and/or repair cost and can be determined in a similar manner as the determination of estimate information described above with respect to block 506 of FIG. 5. Data identifying the estimate information and the future vehicle service(s) can also be provided to a client computing device via a communication network at block 808.

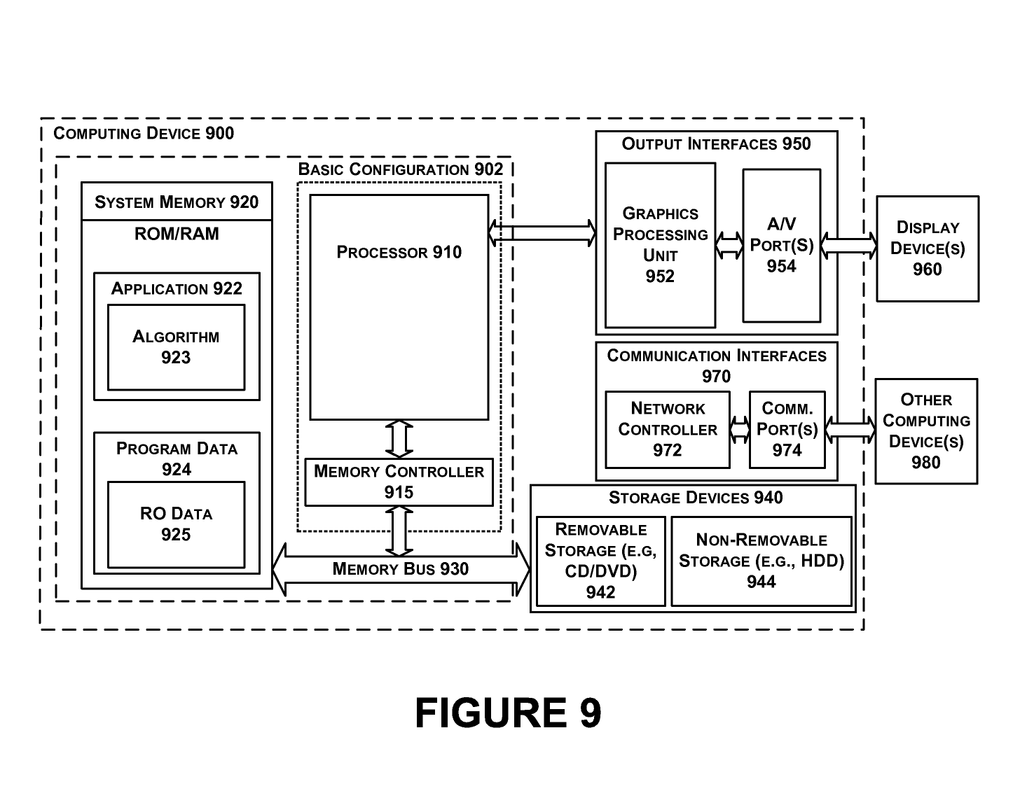

As described above, the computing devices described herein can be any type of computing device. FIG. 9 is a functional block diagram illustrating an example computing device 900 used in a computing system that is arranged in accordance with at least some embodiments described herein. The computing device 900 can be implemented to determine estimate information or perform any of the functions described above with reference to FIGS. 1-8. In a basic configuration 902, computing device 900 can typically include one or more processors 910 and system memory 920. A memory bus 930 can be used for communicating between the processor 910 and the system memory 920. Depending on the desired configuration, processor 910 can be of any type including but not limited to a microprocessor (μP), a microcontroller (μC), a digital signal processor (DSP), or any combination thereof. A memory controller 915 can also be used with the processor 910, or in some implementations, the memory controller 915 can be an internal part of the processor 910.

Depending on the desired configuration, the system memory 920 can be of any type including but not limited to volatile memory (such as RAM), non-volatile memory (such as ROM, flash memory, etc.) or any combination thereof. System memory 920 can include one or more applications 922, and program data 924. Application 922 can include an algorithm 923 that is arranged to receive vehicle information and provide the vehicle information to a communication network or receive vehicle information and determine estimate information, in accordance with the present disclosure. Program data 924 can include repair order data 925 that could be directed to any number of types of data. In some example embodiments, application 922 can be arranged to operate with program data 924 on an operating system.

Computing device 900 can have additional features or functionality, and additional interfaces to facilitate communications between the basic configuration 902 and any devices and interfaces. For example, data storage devices 940 can be provided including removable storage devices 942, non-removable storage devices 944, or a combination thereof. Examples of removable storage and non-removable storage devices include magnetic disk devices such as flexible disk drives and hard-disk drives (HDD), optical disk drives such as compact disc (CD) drives or digital versatile disk (DVD) drives, solid state drives (SSD), and tape drives to name a few. Computer storage media can include volatile and nonvolatile, non-transitory, removable and non-removable media implemented in any method or technology for storage of information, such as computer-readable instructions, data structures, program modules, or other data.

System memory 920 and storage devices 940 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media can be part of device 900.

Computing device 900 can also include output interfaces 950 that can include a graphics processing unit 952, which can be configured to communicate to various external devices such as display devices 960 or speakers via one or more A/V ports 954 or a communication interface 970. The communication interface 970 can include a network controller 972, which can be arranged to facilitate communications with one or more other computing devices 980 over a network communication via one or more communication ports 974. The communication connection is one example of a communication media. Communication media can be embodied by computer-readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media.

Computing device 900 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 can also be implemented as a personal computer, including both laptop computer and non-laptop computer configurations, or a server.

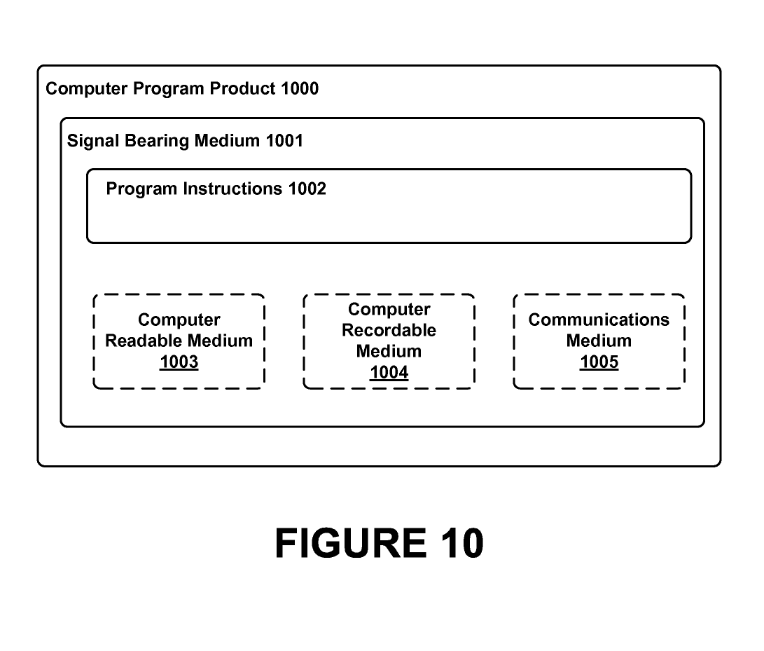

In some embodiments, the disclosed methods can be implemented as computer program instructions encoded on a non-transitory computer-readable storage media in a machine-readable format, or on other non-transitory media or articles of manufacture. FIG. 10 is a schematic illustrating a conceptual partial view of an example computer program product 1000 that includes a computer program for executing a computer process on a computing device, arranged according to at least some embodiments presented herein.

In one embodiment, the example computer program product 1000 is provided using a signal bearing medium 1001. The signal bearing medium 1001 can include one or more programming instructions 1002 that, when executed by one or more processors can provide functionality or portions of the functionality described above with respect to FIGS. 1-9. In some examples, the signal bearing medium 1001 can encompass a computer-readable medium 903, such as, but not limited to, a hard disk drive, a Compact Disc (CD), a Digital Video Disk (DVD), a digital tape, memory, etc. In some implementations, the signal bearing medium 1001 can encompass a computer recordable medium 1004, such as, but not limited to, memory, read/write (R/W) CDs, R/W DVDs, etc. In some implementations, the signal bearing medium 901 can encompass a communications medium 1005, such as, but not limited to, a digital and/or an analog communication medium (e.g., a fiber optic cable, a waveguide, a wired communications link, a wireless communication link, etc.). Thus, for example, the signal bearing medium 1001 can be conveyed by a wireless form of the communications medium 1005 (e.g., a wireless communications medium conforming to the IEEE 802.11 standard or other transmission protocol).

The one or more programming instructions 1002 can be, for example, computer executable and/or logic implemented instructions. In some examples, a computing device such as the computing device 900 of FIG. 9 can be configured to provide various operations, functions, or actions in response to the programming instructions 1002 conveyed to the computing device 900 by one or more of the computer-readable medium 1003, the computer recordable medium 1004, and/or the communications medium 1005.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements can be omitted altogether according to the desired results. Further, many of the elements that are described are functional entities that can be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A method comprising:
receiving, at a computing device, vehicle information comprising (i) a vehicle identifier and (ii) vehicle-usage data for a vehicle;
based on the vehicle information, determining, by the computing device, repair information that relates to the vehicle from a vehicle repair database, wherein the repair information comprises at least one potential vehicle fix to a given malfunction;
determining, by the computing device, estimate information related to the at least one potential vehicle fix, wherein the estimate information related to the at least one potential vehicle fix comprises at least one of (i) a repair time and (ii) a repair cost; and
providing, from the computing device to a communication network, the estimate information related to the at least one potential vehicle fix.

2. The method of claim 1, wherein the vehicle identifier includes an identifier selected from the group consisting of: year, make, model (YMM); year, make, model, engine (YMME); year, make, model, engine, system (YMMES); and vehicle identification number (VIN).

3. The method of claim 1, further comprising:
receiving, at the computing device, repair shop information identifying a particular repair shop, and
wherein determining estimate information related to the at least one potential vehicle fix comprises determining a repair cost based at least in part on a standard repair time for the at least one potential vehicle fix and a shop labor rate associated with the particular repair shop.

4. The method of claim 1, wherein determining estimate information related to the at least one potential vehicle fix comprises determining a range of repair costs for the at least one potential vehicle fix based on repair orders of the vehicle repair database for the at least one potential vehicle fix.

5. The method of claim 4, further comprising:
receiving, at the computing device, repair shop information identifying a particular repair shop, and
wherein the repair orders of the vehicle repair database comprise repair orders for repair shops located within a predetermined geographical range of a location of the particular repair shop.

6. The method of claim 1, wherein the vehicle identifier identifies a particular vehicle type, and the method further comprises:
determining, by the computing device, at least one future vehicle service related to the vehicle using the vehicle repair database, wherein the content of the vehicle repair database comprises data representing failure trends for vehicles of the particular vehicle type;
determining, by the computing device, estimate information related to the at least one future vehicle service; and
providing, from the computing device to the communication network, the estimate information related to the at least one future vehicle service.

7. The method of claim 1, wherein the vehicle information further comprises an indication that a malfunction indicator lamp of the vehicle is illuminated.

8. The method of claim 1, wherein the vehicle information further comprises one or more diagnostic trouble codes.

9. The method of claim 1, further comprising:
receiving symptom information describing a condition of the vehicle, and
wherein the repair information further comprises a successful fix percentage associated with the symptom information.

10. A computing device, comprising:
at least one processor; and
a computer-readable medium, configured to store instructions, that when executed by the at least one processor, cause the computing device to perform functions comprising:
receiving vehicle information comprising (i) a vehicle identifier and (ii) vehicle-usage data for a vehicle,
based on the vehicle information, determining repair information that relates to the vehicle from a vehicle repair database, wherein the repair information comprises at least one potential vehicle fix to a given malfunction,
determining estimate information related to the at least one potential vehicle fix, wherein the estimate information related to the at least one potential vehicle fix comprises at least one of (i) a repair time and (ii) a repair cost, and
providing, to a communication network, the estimate information related to the at least one potential vehicle fix.

11. The computing device of claim 10, wherein the functions further comprise:
receiving repair shop information identifying a particular repair shop, and
wherein determining estimate information related to the at least one potential vehicle fix comprises determining a repair cost based at least in part on a standard repair time for the at least one potential vehicle fix and a shop labor rate associated with the particular repair shop.

12. The computing device of claim 10:
wherein the vehicle identifier identifies a particular vehicle type, and
wherein the functions further comprise:
determining at least one future vehicle service related to the vehicle using the vehicle repair database, wherein the content of the vehicle repair database comprises data representing failure trends for vehicles of the particular vehicle type;
determining estimate information related to the at least one future vehicle service; and
providing to the communication network the estimate information related to the at least one future vehicle service.

13. A method comprising:
receiving, via an interface of a computing device, vehicle information comprising (i) a vehicle identifier and (ii) vehicle-usage data for a vehicle;
providing, by the computing device, the vehicle information to a communication network; and
receiving from the communication network, at the computing device, estimate information related to at least one potential vehicle fix for the vehicle, wherein the estimate information related to the at least one potential vehicle fix comprises at least one of (i) a repair time and (ii) a repair cost.

14. The method of claim 13, further comprising providing, by the computing device, the estimate information related to the at least one potential vehicle fix for display via the interface of the computing device.

15. The method of claim 13, wherein the estimate information related to the at least one potential fix further comprises a range of repair costs for the at least one potential vehicle fix.

16. The method of claim 13, further comprising receiving from the communication network estimate information related to at least one future vehicle service for the vehicle.

17. The method of claim 13, wherein the at least one potential vehicle fix comprises a first fix that involves removing and replacing a first particular part of the vehicle, and the method further comprising receiving from the communication network:
estimate information for a second fix that involves removing and replacing a second particular part of the vehicle that is related to the first particular part of the vehicle,
repair cost data associated with performing the first fix and the second fix during a single repair, and
repair cost data associated with performing the first fix and the second fix during separate repairs.

18. A computing device, comprising:
at least one processor; and
a computer-readable medium, configured to store instructions, that when executed by the at least one processor, cause the computing device to perform functions comprising:
receiving, via an interface of the computing device, vehicle information comprising (i) a vehicle identifier and (ii) vehicle usage data for a vehicle,
providing the vehicle information to a communication network, and
receiving, at the interface and from the communication network, estimate information related to at least one potential vehicle fix to a given malfunction, wherein the estimate information related to the at least one potential vehicle fix comprises at least one of (i) a repair time and (ii) a repair cost.

19. The computing device of claim 18, wherein the estimate information related to the at least one potential fix further comprises a range of repair costs for the at least one potential vehicle fix.

20. The computing device of claim 18, wherein the functions further comprise receiving from the communication network estimate information related to at least one future vehicle service for the vehicle.
